(19) United States
(12) Patent Application Publication
(10) Pub. No.: US 2025/0385937 A1
(43) Pub. Date: Dec. 18, 2025

(54) INJECTION ATTACK PREVENTION FOR DIGITAL IDENTITY VERIFICATION

(71) Applicant: PXL Vision AG, Zurich (CH)

(72) Inventors: Ingo Kossyk, Gais (CH); Julian Kent, Gais (CH)

(73) Assignee: PXL Vision AG, Zurich (CH)

(21) Appl. No.: 19/105,596

(22) PCT Filed: Aug. 23, 2023
(86) PCT No.: PCT/IB2023/000534

§ 371 Date: Feb. 21, 2025

Related U.S. Application Data
(60) Provisional application No. 63/400,265, filed on Aug. 23, 2022.

(51) Int. Cl. H04L 9/40; G06F 3/0346; G06V 10/74; G06V 40/10; G06V 40/40; G06V 40/60; G11B 27/34; H04W 4/02

(52) U.S. Cl. CPC H04L 63/1466; G06F 3/0346; G06V 10/761; G06V 40/10; G06V 40/40; G06V 40/67; G11B 27/34; H04L 63/1416; G06V 2201/10; H04W 4/027

(57) ABSTRACT

Systems and methods for detecting an injection attack during a digital identity verification session are provided. The techniques include obtaining video frames and/or still image frames acquired using a camera of a mobile device, the video frames and/or the still image frames including images of a user and/or an identification document, and obtaining inertial data acquired using an inertial measurement unit (IMU) of the mobile device during the digital identity verification session. The techniques also include determining, using the video frames and/or the still image frames and the inertial data, whether the digital identity verification session is subject to the injection attack.

### RELATED APPLICATIONS

This application claims the benefit under 35 U.S.C. § 119(c) of U.S. Provisional Application Ser. No. 63/400,265, filed Aug. 23, 2022, and entitled “WORKFLOW AND METHOD FOR INJECTION ATTACK PREVENTION FOR DIGITAL IDENTITY VERIFICATION WITH SMARTPHONES,” which is incorporated herein by reference in its entirety.

### BACKGROUND

As advances in electronics have reduced the size of end user computing devices, many people now routinely carry portable computing devices, such as smart phones. As a result, the ability to initiate transactions from convenient places at convenient times has greatly expanded. However, with this expanded flexibility to initiate transactions has come greater risk of unauthorized transactions. Identity verification is widely used to limit transactions initiated from an end-user computer to reduce the risk that unauthorized users will initiate transactions. Most identity verification requires establishing a trust relationship between the authorized user and the system that will process transactions for that user.

### SUMMARY

Some embodiments are directed to a method of detecting an injection attack during a digital identity verification session. The method comprises: obtaining video frames and/or still image frames acquired using a camera of a mobile device, the video frames and/or the still image frames including images of a user and/or an identification document; obtaining inertial data acquired using an inertial measurement unit (IMU) of the mobile device during the digital identity verification session; and determining, using the video frames and/or the still image frames and the inertial data, whether the digital identity verification session is subject to the injection attack.

Some embodiments are directed to a system, comprising: at least one processor; and at least one non-transitory computer-readable medium storing instructions which, when executed by the at least one processor, cause the at least one processor to perform a method of detecting an injection attack during a digital identity verification session. The method comprises: obtaining video frames and/or still image frames acquired using a camera of a mobile device, the video frames and/or the still image frames including images of a user and/or an identification document; obtaining inertial data acquired using an inertial measurement unit (IMU) of the mobile device during the digital identity verification session; and determining, using the video frames and/or the still image frames and the inertial data, whether the digital identity verification session is subject to the injection attack.

Some embodiments are directed to at least one non-transitory computer-readable medium storing instructions which, when executed by at least one processor, cause the at least one processor to perform a method of detecting an injection attack during a digital identity verification session. The method comprises: obtaining video frames and/or still image frames acquired using a camera of a mobile device, the video frames and/or the still image frames including images of a user and/or an identification document; obtaining inertial data acquired using an inertial measurement unit (IMU) of the mobile device during the digital identity verification session; and determining, using the video frames and/or the still image frames and the inertial data, whether the digital identity verification session is subject to the injection attack.

In some embodiments, the inertial data is acquired by the IMU of the mobile device concurrently with acquisition of the video frames and/or the still image frames by the camera of the mobile device.

In some embodiments, determining whether the digital identity verification session is subject to the injection attack comprises correlating the video frames and/or the still image frames with the inertial data.

In some embodiments, the techniques further comprise embedding the inertial data in metadata of correlated video frames and/or correlated still image frames.

In some embodiments, determining whether the digital identity verification session is subject to the injection attack comprises determining, using the inertial data, that the user made micromovements while holding the mobile device during acquisition of the video frames and/or the still image frames.

In some embodiments, obtaining the video frames and/or the still image frames further comprises displaying, using a display device of the mobile device, instructions for the user to move the mobile device.

In some embodiments, the techniques further comprise determining, using inertial data and/or video and/or still image frames acquired in a time window extending for a period after displaying the instructions to move the mobile device, that the user moved the mobile device.

In some embodiments, determining whether the digital identity verification session is subject to the injection attack comprises determining, using video frames and/or still image frames acquired while the user moved the mobile device according to the displayed instructions, whether the video frames and/or the still image frames comprise frames affected by motion blur.

In some embodiments, determining whether the digital identity verification session is subject to the injection attack comprises determining, using inertial data acquired while the user moved the mobile device according to the displayed instructions, that the user moved the mobile device according to the displayed instructions.

In some embodiments, obtaining the video frames and/or the still image frames further comprises displaying, using the display device of the mobile device, instructions for the user to hold the mobile device still.

In some embodiments, the techniques further comprise determining, using inertial data and/or the video frames and/or the still image frames acquired in a time window extending for a period after displaying the instructions to hold the mobile device still, that the user held the mobile device still.

In some embodiments, determining whether the digital identity verification session is subject to the injection attack comprises: performing a similarity measurement between video frames and/or still image frames acquired while the user held the mobile device still and video frames and/or still image frames acquired while the user moved the mobile device according to the displayed instructions; and determining, using the similarity measurement, whether the digital identity verification session is subject to an injection attack.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram illustrating how an injection attack may be performed.

FIG. 2 is a schematic diagram of an illustrative system for performing identification verification, according to some embodiments of the technology described herein.

FIG. 3 is a flowchart describing a method of detecting an injection attack, according to some embodiments of the technology described herein.

FIG. 4 is a schematic diagram of an illustrative computing device on which any aspect of the present disclosure may be implemented.

### DETAILED DESCRIPTION

Systems and methods related to detecting injection attacks (e.g., to steal and/or otherwise use another's identity to perform a transaction) during digital identity verification performed using mobile devices (e.g., mobile phones including smartphones, foldable smartphones, tablets, phablets, personal digital assistants (PDAs), laptops, wearable devices, etc.) are described. Such systems and methods may provide techniques for detecting an injection attack based on data acquired from the mobile device's integrated inertial measurement unit (IMU). For example, accelerometer and/or gyroscope data may be acquired from the mobile device's IMU and correlated with videos and/or still photographs taken by the user using the mobile device during digital identity verification. In this manner, it may be determined whether the user is actually holding and using the mobile device to perform the digital identity verification or if an injection attack is being performed.

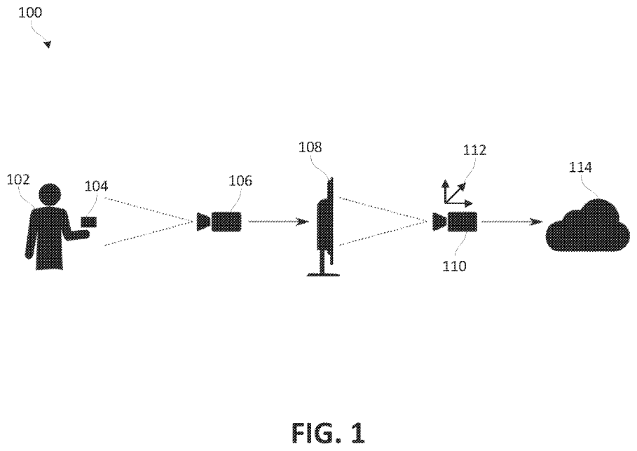

An injection attack avoids the attacker's need to jailbreak the mobile device to attack a digital identity verification system. As shown in FIG. 1, which schematically depicts an injection attack system 100, an injection attack works by recapturing, using a mobile device 110 including a camera and running the digital identity verification system, a modified video stream from a display device 108 (e.g., a television, monitor, and/or video projector) with a sufficiently high resolution. The mobile device 110 may provide its recorded video and/or image stream to a remote identity verification system 114 (e.g., over a network, the internet, cloud computing systems, etc.).

A camera 106 is used by the attacker to film a person 102 (e.g., the attacker him or herself or another person) and/or an identification document (ID) 104 according to the instructions provided by the digital identity verification system running on the mobile device 110. The video that is captured by the camera 106 is modified in real time by tracking the ID 104 using computer vision-based feature tracking (e.g., scale-invariant feature transform (SIFT), speeded-up robust features (SURF), oriented FAST and rotated BRIEF (ORB), etc.) and overlaying parts of the content of a second identification document (not shown) of the same type as ID 104 but including information linked to a different identity. The modified video is then displayed on display device 108 and recaptured using the camera of mobile device 110. These techniques allow the attacker to impersonate the identity that is overlaid on ID 104.

For an injection attack to succeed, the camera of mobile device 110 must be perfectly aligned with the optical axis of the display device 108. If the two are aligned perfectly, the video recapturing cannot be easily detected by conventional digital identity verification techniques. The inventors have recognized and appreciated that, because the success of the injection attack requires the camera of the mobile device 110 to be aligned with the optical axis of the display device 108, the injection attack is most likely to succeed if the mobile device 110 remains perfectly stationary relative to the display device 108. The inventors have further recognized and appreciated that many mobile devices include inertial measurement units (IMUs) with one or more inertial sensors to detect motion of the mobile device. This collected inertial data from the mobile device's IMU 112 may therefore be used by an identity verification system to thwart injection attacks by identifying stationary mobile devices and/or imperfect motion of the mobile device during an identity verification session.

Accordingly, the inventors have developed techniques for detecting injection attacks during digital identity verification sessions using inertial data in combination with imaging data (e.g., recorded video frames and/or still image frames) captured by the mobile device running the digital identity verification session. The techniques include obtaining video frames and/or still image frames acquired using a camera of a mobile device (e.g., a mobile phone such as a smartphone, foldable smartphones, tablets, phablets, personal digital assistants (PDAs), laptops, wearable devices, etc.). For example, the camera may record one or more videos of the user and/or an identification document (ID) during the digital identity verification session. Alternatively or additionally, the camera may capture one or more still image frames (e.g., photographs) of the user and/or the ID during the digital identity verification session.

In some embodiments, the techniques also include obtaining inertial data acquired using an IMU of the mobile device during the digital identity verification session. For example, the inertial data may include data acquired from one or more accelerometers, gyroscopes, and/or magnetometers of the IMU. The inertial data may include one or more of velocity data, acceleration data, angular velocity data, specific force data, and/or orientation data. In some embodiments, the inertial data is acquired by the IMU concurrently with the acquisition of the video frames and/or the still image frames, such that datapoints of the inertial data may be correlated with one or more of the video frames and/or the still image frames. In some embodiments, after correlating the inertial data with one or more of the video frames and/or the still image frames, the inertial data may be embedded in metadata of correlated video frames and/or correlated still image frames such that, if the video frames and/or still image frames are stored, the inertial data may be referenced at a later time (e.g., to reevaluate a previous digital identity verification session).

In some embodiments, the techniques further include determining, using the video frames and/or the still image frames and the inertial data, whether the digital identity verification session is subject to an injection attack. The determination that the digital identity verification session is or is not subject to an injection attack may be implemented using one or more techniques, or a combination of techniques, described herein. As one example, in some embodiments, the determination may be based on, or partially on, a determination that the user made micromovements (e.g., due to tremors, respiration, heartbeats, etc.) while holding the mobile device during acquisition of the video frames and/or the still image frames. The user's micromovements, or lack thereof, may be identified using inertial data acquired during the digital identity verification session. The inertial data may be analyzed to determine whether the mobile device was in fact held by the user during the digital identity verification session, and a lack of micromovements in the inertial data may indicate that the user was not holding the mobile device, indicating a potential injection attack.

As another example, in some embodiments, the determination of whether the digital identity verification session is subject to an injection attack may be made by providing instructions to the user and analyzing the inertial data and/or the video frames and/or still image frames acquired in a time period after the instructions are provided. For example, during the digital identity verification session, instructions (e.g., in the form of words, pictorial representations, or a combination thereof) for the user to move the mobile device in a certain manner (e.g., to shake, tilt, turn, or otherwise reposition the mobile device) may be displayed to the user on a display device (e.g., a screen) of the mobile device. The inertial data and/or the video frames and/or still image frames acquired in a time period after the instructions to move the mobile device are displayed to the user may be analyzed to determine that the user did, in fact, move the mobile device in accordance with the displayed movements. For example, the inertial data acquired within the time period after instructions are provided may be analyzed to determine whether the inertial data indicates the instructed motion (e.g., including changes in acceleration consistent with shaking of the mobile device). Alternatively or additionally, video frames and/or still image frames acquired within the time period may be analyzed to determine whether selected frames include motion blur consistent with the instructed motion. If the inertial data and/or the video frames and/or still image frames indicate motion consistent with the instructions, it may be less likely that the digital identity verification session is subject to an injection attack.

In some embodiments, during the digital identity verification session, instructions for the user to keep the mobile device still may be displayed to the user on a display device of the mobile device. The inertial data and/or the video frames and/or still image frames acquired in a time period after the instructions to keep the mobile device still are displayed to the user may be analyzed to determine that the user did, in fact, hold the mobile device still. For example, the inertial data acquired within the time period after instructions are provided may be analyzed to determine whether the inertial data indicates that the mobile device was not moved for a time (e.g., including limited changes in acceleration consistent with holding the mobile device still). Alternatively or additionally, video frames and/or still image frames acquired within the time period may be analyzed to determine whether selected frames do not include motion blur consistent with holding the mobile device still. If the inertial data and/or the video frames and/or still image frames indicate a lack of motion consistent with the instructions, it may be less likely that the digital identity verification session is subject to an injection attack.

In some embodiments, during the digital identity verification session, a set of instructions may be sequentially provided to the user to hold the mobile device still and then to move the mobile device in a particular manner (or vice versa). Inertial data and/or video frames and/or still image frames acquired during time periods after the display of each of the sequential instructions may be analyzed to determine whether the user followed the displayed instructions. In some embodiments, first video frames and/or still image frames may be selected from a first time period after a first instruction is provided and second video frames and/or still image frames may be selected from a second time period after a second instruction is provided. Similarity measurements may be performed to measure differences between the first video frames and/or still image frames and the second video frames and/or still image frames. The measured similarity between the first video frames and/or still image frames and the second video frames and/or still image frames may be used to determine whether the digital identity verification session is subject to an injection attack. For example, it may be assumed that a similarity measurement between images acquired while moving the mobile device and images acquired while holding the mobile device still may be low (e.g., as features are affected by motion blur and/or different features are captured in the images). Thus, a low similarity measurement may be associated with an increased likelihood that the digital identity verification session is not subject to an injection attack.

Following below are more detailed descriptions of various concepts related to, and embodiments of, techniques for the detection of injection attacks. It should be appreciated that various aspects described herein may be implemented in any of numerous ways. Examples of specific implementations are provided herein for illustrative purposes only. In addition, the various aspects described in the embodiments below may be used alone or in any combinations and are not limited to the combinations explicitly described herein.

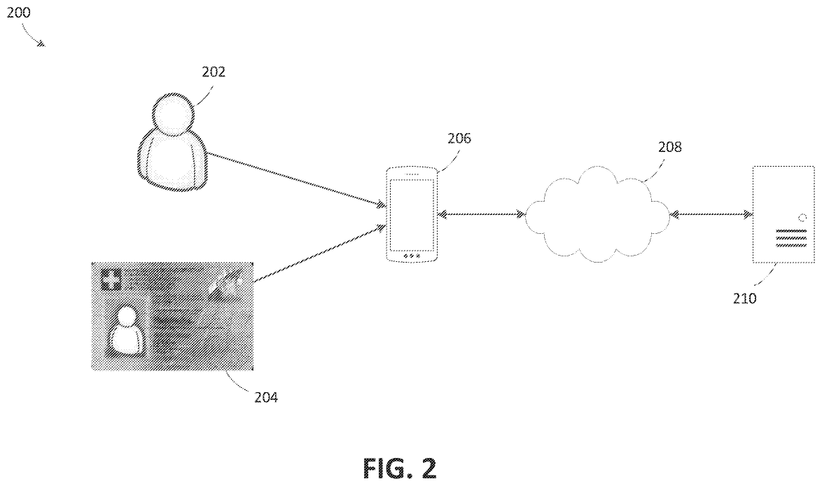

FIG. 2 depicts, schematically, an illustrative system 200 for implementing a digital identity verification session to verify the identity of a user 202 and/or the validity of an identification document (ID) 204. According to some embodiments, the system 200 may include an end-user device 206 (e.g., a mobile device as described above) that is equipped with a camera that can capture images and/or video of the user 202 and/or the ID 204. In some embodiments, the end-user device 206 may communicate with a remote server 210 through a cloud connection 208 to transmit data, such as the captured images of the user 202 and/or the ID 204 and/or results of processing of images of a user and/or identification documents. The remote server 210 may be a server that performs a transaction initiated by user 202 or may be a separate authentication server that communicates authentication information to another server (not pictured) that may be programmed to implement a transaction when the authentication server provides authenticated information from which the transaction server may determine that user 202 is an authorized user.

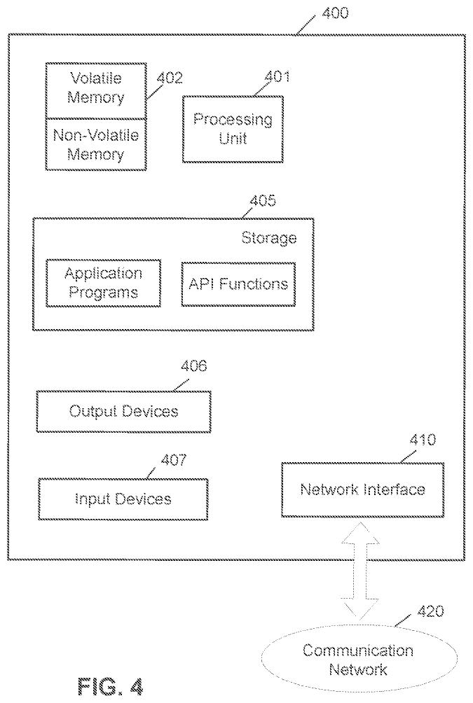

In some embodiments, the end-user device 206 may be a computing device, examples of which are discussed in more detail in connection with FIG. 4. The end-user device 206 may include a camera or may be otherwise suitably electrically coupled with a camera for capturing images used for identity verification. The camera may be such that images of user 202 and/or ID 204 may be captured from multiple angles. In the example of FIG. 2, the end-user device 206 is depicted as a portable computing device (e.g., a smartphone), such that images may be captured from multiple angles by moving the portable computing device. In embodiments in which the end-user device 206 is a non-portable computing device (e.g., a personal computer), images may be captured from multiple angles by moving the camera relative to the computing device, moving the ID 204 relative to the camera, or having the user 202 move relative to the camera.

In some embodiments, the end-user device 206 may additionally include an integrated inertial measurement unit (IMU). The integrated IMU may include one or more accelerometers, gyroscopes, and/or magnetometers configured to measure inertial data along three principal axes (e.g., corresponding to pitch, roll, and yaw). For example, the inertial data may include one or more of velocity data, acceleration data, angular velocity data, specific force data, and/or orientation data relating to motion of the end-user device 206.

To perform user and/or ID verification, the end-user device 206 may capture one or more images of the user 202 and/or the user's ID 204. The end-user device 206 may perform image processing on the captured images to prepare the captured images for verification. The end-user device 206 may perform the process of verification on a local processor or may transfer data through cloud connection 208 to the remote server 210 so that the remote server 210 may perform the process of identity verification. The techniques as described herein may require sufficiently low computational resources and external data that they may be performed on a portable computing device, which may have significantly less computing power and access to data than a network connected server. In embodiments in which the verification is performed on a local processor of the end-user device 206, the local processor may transmit the results of that processing to the remote server 210. Those results and, in some embodiments any or all other information, may be transmitted between the end-user device 206 and the remote server 210 in an encrypted format. Additional aspects of performing digital identity verification are described in U.S. Pat. No. 11,669,607, titled “ID Verification with a Mobile Device,” filed Aug. 28, 2020, which is incorporated herein by reference in its entirety.

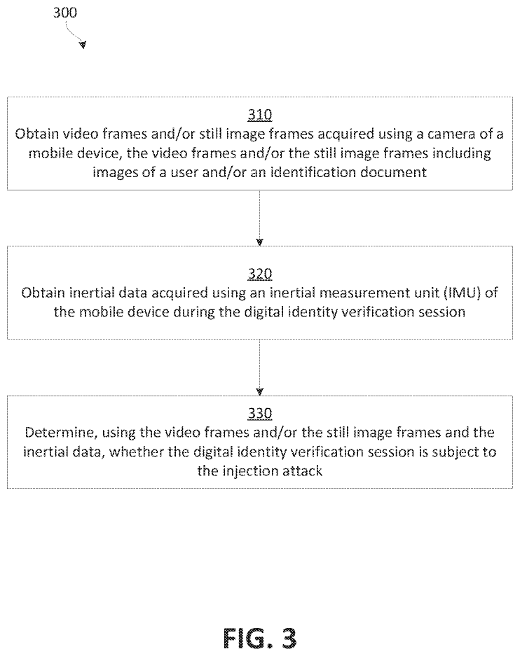

FIG. 3 is a flowchart describing a process 300 of detecting an injection attack affecting a digital identity verification session, according to some embodiments of the technology described herein. The process 300 may be executed using any suitable computing device. For example, in some embodiments, the process 300 may be performed by the mobile device implementing the digital identity verification session. As another example, in some embodiments, the process 300 may be performed by one or more processors located remotely from the mobile device implementing the digital identity verification session. The one or more remote processors may be, for example, a remote server (e.g., remote server 210 described in connection with FIG. 2 herein) that may perform a transaction initiated by the user of the mobile device. Alternatively, the remote server may be a separate authentication server that communicates authentication information to another server that may be programmed to implement the initiated transaction when the authentication server provides authenticated information from which the transaction server may determine that the user of the mobile device is an authorized user. The remote server may be a computing device as described in connection with FIG. 4 herein.

In some embodiments, process 300 may begin with act 310, in which video frames and/or still image frames may be obtained. The video frames and/or still image frames may have been acquired using a camera of a mobile device (e.g., the mobile device implementing the digital identity verification session) during the digital identity verification session. The video frames and/or still image frames may be obtained by the computing device executing the process 300 directly from the camera of the mobile device. Alternatively or additionally, the computing device may obtain the video frames and/or the still image frames by retrieving the frames from one or more computer memories (e.g., a computer memory of the mobile device, a computer memory located remotely from the mobile device) or by receiving the frames via a transmission between one or more computing and/or mobile devices.

The mobile device may be, as non-limiting examples a mobile phone such as a smartphone, foldable smartphones, tablets, phablets, personal digital assistants (PDAs), laptops, and/or a wearable device, in some embodiments. During the digital identity verification session, the user may be asked (e.g., by instructions displayed on a screen of the mobile device) to take a picture or a video of themselves showing their ID to the camera or to take a video of their ID using the camera. The obtained video frames and/or still image frames may therefore include images of a user and/or an ID.

In some embodiments, after act 310, the process 300 may proceed to act 320, in which inertial data may be obtained. The inertial data may have been acquired by an IMU of the mobile device during the digital identity verification session. The inertial data may be obtained by the computing device executing the process 300 directly from the camera of the mobile device. Alternatively or additionally, the computing device may obtain the inertial data by retrieving the inertial data from one or more computer memories (e.g., a computer memory of the mobile device, a computer memory located remotely from the mobile device) or by receiving the inertial data via a transmission between one or more computing and/or mobile devices.

In some embodiments, the inertial data may include data acquired from one or more accelerometers, gyroscopes, and/or magnetometers of the IMU. The inertial data may include one or more of velocity data, acceleration data, angular velocity data, specific force data, and/or orientation data. In some embodiments, the inertial data may be acquired by the IMU concurrently with the acquisition of the video frames and/or the still image frames, such that datapoints of the inertial data may be correlated with one or more of the video frames and/or the still image frames.

In some embodiments, after correlating the inertial data with one or more of the video frames and/or the still image frames, some or all of inertial data may be embedded in metadata of correlated video frames and/or correlated still image frames. Embedding some or all of the inertial data in the video frames and/or the still image frames may enable later reevaluation of a previous digital identity verification session.

In some embodiments, after act 320, the process 300 may proceed to act 330, in which it may be determined whether the digital identity verification session has been subject to an injection attack. The determination may be made using one or both of the inertial data and/or the video frames and/or the still image frames obtained in acts 310 and 320. The determination that the digital identity verification session is or is not subject to an injection attack may be implemented using one or more techniques, or a combination of techniques, described herein.

As one example, in some embodiments, the determination may be based on, or partially on, a determination that the user made micromovements (e.g., due to tremors, respiration, heartbeats, etc.) while holding the mobile device during acquisition of the video frames and/or the still image frames. The inertial data may be recorded in the background of the digital identity verification session without giving feedback to the user. The user's micromovements, or lack thereof, may be identified using the inertial data acquired during the digital identity verification session.

In some embodiments, the inertial data may be analyzed to determine whether the mobile device was in fact held by the user during the digital identity verification session, and a lack of micromovements in the inertial data may indicate that the user was not holding the mobile device during the digital identity verification session. The analysis of the inertial data may be performed using signal processing and/or machine learning techniques (e.g., deep learning, convolutional neural networks, etc.). In this manner, even small micromovements of the user may be detected based on the inertial data generated by the mobile device. If no movement of the mobile device is detected, it may be determined that the mobile device was not used according to instructions or that the digital identity verification session is under attack via an injection attack.

As another example, in some embodiments, the determination of whether the digital identity verification session is subject to an injection attack may be made by providing instructions to the user and analyzing the inertial data, the video frames, and/or the still image frames acquired during time periods after the instructions are provided (e.g., within a few seconds after the instructions are provided). For example, during the digital identity verification session, instructions (e.g., in the form of words, pictorial representations, or a combination thereof) for the user to point the camera at the user's face and/or the ID and to move the mobile device in a certain manner (e.g., to shake, tilt, turn, or otherwise reposition the mobile device) may be displayed to the user on a display device (e.g., a screen) of the mobile device. The inertial data, the video frames, and/or the still image frames acquired in a time period after the instructions to move the mobile device are displayed to the user may be analyzed to determine that the user did, in fact, move the mobile device in accordance with the displayed movements. For example, the inertial data acquired within the time period after instructions are provided may be analyzed to determine whether the inertial data indicates the instructed motion (e.g., including changes in acceleration consistent with shaking of the mobile device). Alternatively or additionally, video frames and/or still image frames acquired within the time period may be analyzed to determine whether selected frames include motion blur consistent with the instructed motion. If the inertial data and/or the video frames and/or still image frames indicate motion consistent with the instructions, it may be less likely that the digital identity verification session is subject to an injection attack.

In some embodiments, during the digital identity verification session, instructions for the user to keep the mobile device still may be displayed to the user on a display device of the mobile device. The inertial data and/or the video frames and/or still image frames acquired in a time period after the instructions to keep the mobile device still are displayed to the user may be analyzed to determine that the user did, in fact, hold the mobile device still. For example, the inertial data acquired within the time period after instructions are provided may be analyzed to determine whether the inertial data indicates that the mobile device was not moved for a time (e.g., including limited changes in acceleration consistent with holding the mobile device still). Alternatively or additionally, video frames and/or still image frames acquired within the time period may be analyzed to determine whether selected frames do not include motion blur consistent with holding the mobile device still. If the inertial data and/or the video frames and/or still image frames indicate a lack of motion consistent with the instructions, it may be less likely that the digital identity verification session is subject to an injection attack.

During an injection attack, the camera of the mobile device typically remains fixed and calibrated with respect to the screen displaying the recaptured footage. To follow the instructions to move the mobile device, an attacker would need to shake the mobile device at the right point in time and perfectly realign the camera with respect to the screen in order to fool the identity verification system. This requirement therefore increases the complexity of performing the attack. Alternatively, if an attacker were to shake the camera used to capture video of the attacker rather than the mobile device, the inertial data from the mobile device would not indicate shaking movements, therefore also identifying an injection attack.

In some embodiments, during the digital identity verification session, a set of instructions may be sequentially provided to the user to hold the mobile device still and then to move the mobile device in a particular manner (or vice versa). Inertial data and/or video frames and/or still image frames acquired during time periods after the display of each of the sequential instructions may be analyzed to determine whether the user followed the displayed instructions. In some embodiments, first video frames and/or still image frames may be selected from a first time period after a first instruction is provided and second video frames and/or still image frames may be selected from a second time period after a second instruction is provided. Similarity measurements may be performed to measure differences between the first video frames and/or still image frames and the second video frames and/or still image frames. The measured similarity between the first video frames and/or still image frames and the second video frames and/or still image frames may be used to determine whether the digital identity verification session is subject to an injection attack. For example, it may be assumed that a similarity measurement between images acquired while moving the mobile device and images acquired while holding the mobile device still may be low (e.g., as features are affected by motion blur and/or different features are captured in the images). Thus, a low similarity measurement may be associated with an increased likelihood that the digital identity verification session is not subject to an injection attack.

As described above, the user may be asked at randomly-selected points in time or at different intervals to shake their mobile device, to hold the mobile device still, or to perform other specific movements. Because the identity verification session is running on the mobile device (as in mobile device 110 of FIG. 1) and the mobile device should be in a fixed position on the optical axis of the screen displaying the recaptured footage during an injection attack, shaking the mobile device will lead two different outcomes. First, if the mobile device is mechanically fixed with respect to the screen, the recorded video will remain sharp during periods of motion as the screen and the mobile device will be shaken at the same time. This can be detected by analysis of the captured images since it is expected that shaking the camera will lead to motion blur of the identity document during the video recording. Second, if the mobile device is not mechanically coupled to the screen, then it may be difficult to reposition the mobile device after shaking, as the mobile device would have to be returned to a position where it is perfectly re-aligned with the optical axis of the screen. A misalignment of the mobile device and the screen may therefore be detected after periods of motion of the mobile device.

In some injection attacks, an attacker may shake the camera used for recapture (e.g., camera 106 of FIG. 1) during the digital identity verification session. Precise feature detection and tracking in order to digitally modify the video stream shown on the screen, however, requires a sharp picture captured by the camera in order to match correspondences between the target identification document and the identification document used during the attack. Thus, tracking of the identification document will be disrupted by shaking the camera, making the overlay of stolen identity data in real time difficult. Moreover, since the camera is not directly running the digital identity verification application, the shaking movement will not be detectable in the inertial data generated by the mobile device. In some embodiments, these features can be used to determine in a robust fashion whether an injection attack is occurring and whether the user is following the instructions displayed by the mobile device.

In attacks where the attacker shakes the camera used for video recapture, the video data acquired may be analyzed to determine whether the information shown on the identification document remains the same when the mobile device is held still as when the mobile device is shaken. If the information shown on the identification document is different when the mobile device is shaken, this is indicative of an attack. To make this determination, in some embodiments, methods including motion deblurring using machine learning (e.g., neural networks) can be employed at the server when evaluating the video in order to deblur the respective video frames for analysis.

In some embodiments, frames of the video acquired while the user is shaking the camera can be deblurred (e.g., again potentially using the IMU recording) to a degree so that the difference between the digitally tampered and pristine ID can be detected. In some embodiments, a similarity metric can be employed to determine whether the image of the ID has been tampered with using suitable computer vision algorithms (e.g., GIST descriptors or machine learning models).

As described herein, the correlation of inertial data and video or picture data acquired from the mobile device running the digital identity verification system render the injection attack described in connection with FIG. 1 as being very difficult and/or impracticable. Moreover, with an increasing complexity in the countermeasures, the level of security increases, as the countermeasures require a potential attacker to understand the countermeasure in detail and adjust the attack method accordingly.

FIG. 4 shows, schematically, an illustrative computer 400 on which the methods described above may be implemented. Illustrative computer 400 may represent an end-user device (e.g., end-user device 206) and/or a remote server (e.g., remote server 420). The computer 400 includes a processing unit 401 having one or more processors and a non-transitory computer-readable storage medium 402 that may include, for example, volatile and/or non-volatile memory. The memory 402 may store one or more instructions to program the processing unit 401 to perform any of the functions described herein. The computer 400 may also include other types of non-transitory computer-readable medium, such as storage 405 (e.g., one or more disk drives) in addition to the system memory 402. The storage 405 may also store one or more application programs and/or resources used by application programs (e.g., software libraries), which may be loaded into the memory 402.

The computer 400 may have one or more input devices and/or output devices, such as devices 406 and 407 illustrated in FIG. 4. These devices may be used, for instance, to present a user interface. Examples of output devices that may be used to provide a user interface include printers and display screens for visual presentation of output, and speakers and other sound generating devices for audible presentation of output. Examples of input devices that may be used for a user interface include keyboards and pointing devices (e.g., mice, touch pads, and digitizing tablets). As another example, the input devices 407 may include a microphone for capturing audio signals, a camera for capturing images and/or videos, and/or inertial sensors for capturing inertial data related to the motion of the computer 400. The output devices 406 may include a display screen for visually rendering, and/or a speaker for audibly rendering. recognized text.

In the example shown in FIG. 4, the computer 400 also includes one or more network interfaces (e.g., the network interface 410) to enable communication via various networks (e.g., the network 420). Examples of networks include a local area network (e.g., an enterprise network) and a wide area network (e.g., the Internet). Such networks may be based on any suitable technology and operate according to any suitable protocol and may include wireless networks and/or wired networks (e.g., fiber optic networks).

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the data and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be tangible (e.g., non-transitory) computer readable media. In some embodiments, the computer readable media may comprise a persistent memory.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising.” “including.” “carrying.” “having.” “containing.” “involving,” “holding,” “composed of.” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A method of detecting an injection attack during a digital identity verification session, the method comprising:
obtaining video frames and/or still image frames acquired using a camera of a mobile device, the video frames and/or the still image frames including images of a user and/or an identification document;
obtaining inertial data acquired using an inertial measurement unit (IMU) of the mobile device during the digital identity verification session; and
determining, using the video frames and/or the still image frames and the inertial data, whether the digital identity verification session is subject to the injection attack.

2. The method of claim 1, wherein the inertial data is acquired by the IMU of the mobile device concurrently with acquisition of the video frames and/or the still image frames by the camera of the mobile device.

3. The method of claim 2, wherein determining whether the digital identity verification session is subject to the injection attack comprises correlating the video frames and/or the still image frames with the inertial data.

4. The method of claim 3, further comprising embedding the inertial data in metadata of correlated video frames and/or correlated still image frames.

5. The method of claim 1, wherein determining whether the digital identity verification session is subject to the injection attack comprises determining, using the inertial data, that the user made micromovements while holding the mobile device during acquisition of the video frames and/or the still image frames.

6. The method of claim 1, wherein obtaining the video frames and/or the still image frames further comprises displaying, using a display device of the mobile device, instructions for the user to move the mobile device.

7. The method of claim 6, further comprising determining, using inertial data and/or video and/or still image frames acquired in a time window extending for a period after displaying the instructions to move the mobile device, that the user moved the mobile device.

8. The method of claim 7, wherein determining whether the digital identity verification session is subject to the injection attack comprises:
determining, using video frames and/or still image frames acquired while the user moved the mobile device according to the displayed instructions, whether the video frames and/or the still image frames comprise frames affected by motion blur.

9. The method of claim 7, wherein determining whether the digital identity verification session is subject to the injection attack comprises:
determining, using inertial data acquired while the user moved the mobile device according to the displayed instructions, that the user moved the mobile device according to the displayed instructions.

10. The method of claim 6, wherein obtaining the video frames and/or the still image frames further comprises displaying, using the display device of the mobile device, instructions for the user to hold the mobile device still.

11. The method of claim 10, further comprising determining, using inertial data and/or the video frames and/or the still image frames acquired in a time window extending for a period after displaying the instructions to hold the mobile device still, that the user held the mobile device still.

12. The method of claim 11 wherein determining whether the digital identity verification session is subject to the injection attack comprises:
performing a similarity measurement between video frames and/or still image frames acquired while the user held the mobile device still and video frames and/or still image frames acquired while the user moved the mobile device according to the displayed instructions; and
determining, using the similarity measurement, whether the digital identity verification session is subject to an injection attack.

13. A system, comprising:
at least one processor; and
at least one non-transitory computer-readable medium storing instructions which, when executed by the at least one processor, cause the at least one processor to perform a method of detecting an injection attack during a digital identity verification session, the method comprising:
obtaining video frames and/or still image frames acquired using a camera of a mobile device, the video frames and/or the still image frames including images of a user and/or an identification document;
obtaining inertial data acquired using an inertial measurement unit (IMU) of the mobile device during the digital identity verification session; and
determining, using the video frames and/or the still image frames and the inertial data, whether the digital identity verification session is subject to the injection attack.

14. The system of claim 13, wherein the inertial data is acquired by the IMU of the mobile device concurrently with acquisition of the video frames and/or the still image frames by the camera of the mobile device.

15. The system of claim 14, wherein determining whether the digital identity verification session is subject to the injection attack comprises correlating the video frames and/or the still image frames with the inertial data.

16. The system of claim 15, further comprising embedding the inertial data in metadata of correlated video frames and/or correlated still image frames.

17. The system of claim 13, wherein determining whether the digital identity verification session is subject to the injection attack comprises determining, using the inertial data, that the user made micromovements while holding the mobile device during acquisition of the video frames and/or the still image frames.

18. The system of claim 13, wherein obtaining the video frames and/or the still image frames further comprises displaying, using a display device of the mobile device, instructions for the user to move the mobile device.

19. The system of claim 18, further comprising determining, using inertial data and/or video and/or still image frames acquired in a time window extending for a period after displaying the instructions to move the mobile device, that the user moved the mobile device.

20. The system of claim 19, wherein determining whether the digital identity verification session is subject to the injection attack comprises:
determining, using video frames and/or still image frames acquired while the user moved the mobile device according to the displayed instructions, whether the video frames and/or the still image frames comprise frames affected by motion blur.

21. The system of claim 19, wherein determining whether the digital identity verification session is subject to the injection attack comprises:
determining, using inertial data acquired while the user moved the mobile device according to the displayed instructions, that the user moved the mobile device according to the displayed instructions.

22. The system of claim 18, wherein obtaining the video frames and/or the still image frames further comprises displaying, using the display device of the mobile device, instructions for the user to hold the mobile device still.

23. The system of claim 22, further comprising determining, using inertial data and/or the video frames and/or the still image frames acquired in a time window extending for a period after displaying the instructions to hold the mobile device still, that the user held the mobile device still.

24. The system of claim 23 wherein determining whether the digital identity verification session is subject to the injection attack comprises:
performing a similarity measurement between video frames and/or still image frames acquired while the user held the mobile device still and video frames and/or still image frames acquired while the user moved the mobile device according to the displayed instructions; and
determining, using the similarity measurement, whether the digital identity verification session is subject to an injection attack.

25. At least one non-transitory computer-readable medium storing instructions which, when executed by at least one processor, cause the at least one processor to perform a method of detecting an injection attack during a digital identity verification session, the method comprising:
obtaining video frames and/or still image frames acquired using a camera of a mobile device, the video frames and/or the still image frames including images of a user and/or an identification document;
obtaining inertial data acquired using an inertial measurement unit (IMU) of the mobile device during the digital identity verification session; and
determining, using the video frames and/or the still image frames and the inertial data, whether the digital identity verification session is subject to the injection attack.
